(19) United States
(12) Patent Application Publication
(10) Pub. No.: US 2020/0270808 A1
(43) Pub. Date: Aug. 27, 2020

(54) TEXTILE PRINTING INK JET INK COMPOSITION AND TEXTILE PRINTING METHOD

(71) Applicant: Seiko Epson Corporation, Tokyo (JP)

(72) Inventors: Shugo HATTORI, Shiojiri (JP); Takayoshi KAGATA, Shiojiri (JP); Katsuko AOKI, Matsumoto (JP)

(21) Appl. No.: 16/801,516

(22) Filed: Feb. 26, 2020

(30) Foreign Application Priority Data
Feb. 27, 2019 (JP) 2019-033842

(51) Int. Cl. D06P 5/30; C09D 11/328; B41J 3/407; D06P 1/22

(52) U.S. Cl. CPC D06P 5/30; D06P 1/228; B41J 3/4078; C09D 11/328

(57) ABSTRACT

According to the present disclosure, a textile printing ink jet ink composition includes a thioindigo-skeleton-containing dye and elemental sulfur. A content of the elemental sulfur in the textile printing ink jet ink composition is 0.01 ppm or greater and 500 ppm or less relative to the total mass of the ink composition.

The present application is based on, and claims priority from, JP Application Serial Number 2019-033842, filed Feb. 27, 2019, the disclosure of which is hereby incorporated by reference herein in its entirety.

### BACKGROUND

### 1. Technical Field

The present disclosure relates to a textile printing ink jet ink composition and a textile printing method.

### 2. Related Art

Textile printing is a known process for recording an image on a fabric, such as a woven fabric, a knit fabric, or a nonwoven fabric. In recent years, studies have been conducted on using an ink jet recording process in textile printing. In the ink jet textile printing, which utilizes the ink jet recording process, an image made of an ink film is formed on a fabric by ejecting droplets of an ink composition from the nozzles of a recording head and depositing the droplets on the fabric.

One embodiment of the ink jet textile printing is a textile printing method utilizing a sublimation transfer process in which a sublimation dye is used. In this method, ink is not directly deposited on a fabric that serves as a textile printing object, but an ink composition is deposited on a transfer medium that serves as a transfer source, such as paper, and thereafter, the dye is transferred from the transfer medium to the fabric that is a textile printing object, thereby obtaining a recorded product, which is a transfer product.

To obtain a transfer product having an excellent balance between color saturation and color development in a textile printing method using a sublimation transfer process, there have been proposed textile printing ink jet ink compositions in which a thioindigo-skeleton-containing dye, such as C.I. Vat Red, is used (e.g., JP-A-2016-190933).

With regard to textile printing ink jet ink compositions in which a thioindigo-skeleton-containing dye is used, there is a need to enhance storage stability and to suppress an odor during the heating of a fabric or an intermediate transfer medium.

### SUMMARY

1. A textile printing ink jet ink composition including a thioindigo-skeleton-containing dye and elemental sulfur, wherein a content of the elemental sulfur is 0.01 ppm or greater and 500 ppm or less relative to a total mass of the textile printing ink jet ink composition.

2. The textile printing ink jet ink composition according to 1, wherein the content of the elemental sulfur is 20 ppm or greater and 100 ppm or less relative to the total mass of the textile printing ink jet ink composition.

3. The textile printing ink jet ink composition according to 1 or 2, wherein the thioindigo-skeleton-containing dye is at least one selected from the group consisting of C.I. Disperse Red 364, C.I. Vat Orange 5, C.I. Vat Red 1, C.I. Vat Red 5, C.I. Vat Red 6, C.I. Vat Violet 3, and C.I. Vat Violet 4.

4. The textile printing ink jet ink composition according to any one of 1 to 3, wherein a content of the thioindigo-skeleton-containing dye is 0.1 mass % or greater and 10.0 mass % or less relative to the total mass of the textile printing ink jet ink composition.

5. A textile printing method including a deposition step of depositing a textile printing ink jet ink composition onto a transfer sheet by using an ink jet method and a transfer step of, after the deposition step, positioning the transfer sheet and a recording medium to face each other and heating the transfer sheet and the recording medium, wherein the textile printing ink jet ink composition includes a thioindigo-skeleton-containing dye and elemental sulfur, and a content of the elemental sulfur in the textile printing ink jet ink composition is 0.01 ppm or greater and 500 ppm or less relative to a total mass of the textile printing ink jet ink composition.

6. The textile printing method according to 5, wherein a transfer temperature in the transfer step is 160° C. or higher and 240° C. or lower.

7. The textile printing method according to 5 or 6, wherein a transfer time in the transfer step is 20 seconds or more and 100 seconds or less.

### DESCRIPTION OF EXEMPLARY EMBODIMENTS

Some embodiments of the present disclosure will now be described. The embodiments described below are examples of the present disclosure. The present disclosure is in no way limited to the embodiments described below. The present disclosure includes various modified embodiments implemented within a scope that does not deviate from the gist of the present disclosure. Note that not all of the configurations described below may be essential configurations of the present disclosure.

According to an embodiment, a textile printing ink jet ink composition includes a thioindigo-skeleton-containing dye and elemental sulfur. A content of the elemental sulfur in the textile printing ink jet ink composition is 0.01 ppm or greater and 500 ppm or less relative to the total mass of the ink composition.

According to an embodiment, a textile printing method includes a deposition step and a transfer step. In the deposition step, a textile printing ink jet ink composition is deposited onto a transfer sheet by using an ink jet method. In the transfer step, which is performed after the deposition step, the transfer sheet and a recording medium are positioned to face each other and heated. The textile printing ink jet ink composition includes a thioindigo-skeleton-containing dye and elemental sulfur. A content of the elemental sulfur in the textile printing ink jet ink composition is 0.01 ppm or greater and 500 ppm or less relative to the total mass of the ink composition.

The textile printing ink jet ink composition (hereinafter also referred to as an “ink composition” or “ink”) and the textile printing method according to embodiments will now be described.

### 1. TEXTILE PRINTING INK JET INK COMPOSITION

The textile printing ink jet ink composition according to an embodiment includes a thioindigo-skeleton-containing dye and elemental sulfur. A content of the elemental sulfur in the textile printing ink jet ink composition is 0.01 ppm or greater and 500 ppm or less relative to the total mass of the ink composition.

Components included in the textile printing ink jet ink composition of the embodiment will be described below.

### 1.1. Thioindigo-Skeleton-Containing Dye

The textile printing ink jet ink composition according to the embodiment includes a thioindigo-skeleton-containing dye.

Examples of the thioindigo-skeleton-containing dye include thioindigo that is an indigo molecule derivative in which the two NH groups are substituted with two sulfur atoms. Thioindigo is an organosulfur compound and a type of disperse dye. A disperse dye is a type of sublimation dye and a compound that is water insoluble or has a low water solubility. A disperse dye is suitable for use in the coloring of hydrophobic synthetic fibers, such as polyester, nylon, and acetate.

As used herein, the term “sublimation dye” refers to a dye having the property of sublimating when heated. The dye is suitable for the dyeing of fabrics and the like that utilizes sublimation transfer, that is, textile printing. An example of a textile printing method utilizing sublimation transfer is as follows. With an ink jet method, printing is performed on a sheet-shaped intermediate transfer medium that serves as a transfer source, such as paper, by using an ink containing a sublimation dye. Thereafter, the intermediate transfer medium is laid over a recording medium, such as a fabric, and then heating is performed to carry out sublimation transfer. Another example of the method is as follows. A recording medium provided with a peelable ink-receiving layer, such as a film product, is prepared. With an ink jet method, printing is performed on the ink-receiving layer by using a sublimation transfer ink, and then heating is performed to carry out sublimation diffusion dyeing on the recording medium, which is located on the lower layer side. Thereafter, the ink-receiving layer is removed.

Thioindigo, which is also referred to as C.I. Disperse Red 364, C.I. Vat Red 41, or C.I. Solvent Red 242, has the molecular formula of C16H802S2. Also, thioindigo is 2-(3-oxo-1-benzothiophene-2(3H)-ylidene)-1-benzothiophene-3(2H)-one and is a heterocyclic compound represented by general formula (1).

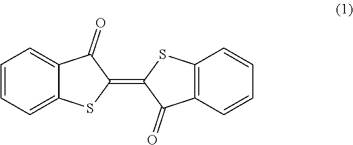

Thioindigo can be prepared by alkylating the sulfur in thiosalicylic acid with chloroacetic acid and then cyclizing the resultant thioether into 2-hydroxy thianaphthen and converting the 2-hydroxy thianaphthen. Disperse dyes also include compounds related to thioindigo. Examples of such compounds include a compound produced by chlorinating thioindigo.

Examples of thioindigo-skeleton-containing dyes include C.I. Disperse Red 364, and in addition, the following compounds: C.I. Vat Orange 5, which is a compound represented by general formula (2); C.I. Vat Red 1, which is a compound represented by general formula (3); C.I. Vat Red 5, which is a compound represented by general formula (4); C.I. Vat Red 6, which is a compound represented by general formula (5); C.I. Vat Violet 3, which is a compound represented by general formula (6); and C.I. Vat Violet 4, which is a compound represented by general formula (7).

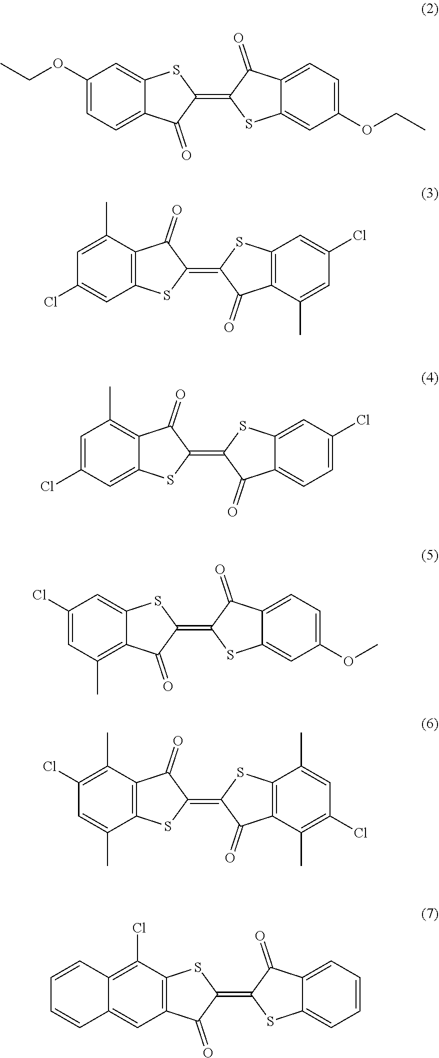

Since the above-mentioned thioindigo-skeleton-containing dyes are organosulfur compounds containing sulfur in the skeleton, the dyes include elemental sulfur derived from the raw material used for the synthesis remaining therein. As a result, in cases in which an ink that contains such a dye is used for textile printing, an odor derived from the elemental sulfur may be produced during the heating of a fabric or an intermediate transfer medium that includes the applied ink. On the other hand, it has been found that if the ink is made to be free of elemental sulfur by purification, storage stability decreases.

Accordingly, as will be described later, in the textile printing ink jet ink composition according to the embodiment, the content of elemental sulfur in the ink composition is appropriately controlled; specifically, the content is 0.01 ppm or greater and 500 ppm or less relative to the total mass of the ink composition. Consequently, the textile printing ink jet ink composition has excellent storage stability and enables suppression of an odor during heating.

Furthermore, a content of the thioindigo-skeleton-containing dye in the ink composition is preferably 0.1 mass % or greater and 10.0 mass % or less, more preferably 1.0 mass % or greater and 7.0 mass % or less, and even more preferably 2.0 mass % or greater and 6.0 mass % or less, relative to the total mass of the ink composition. When the content of the dye in the ink composition is within any of the above-mentioned ranges, the resultant transfer product exhibits sufficient color development. Furthermore, the textile printing ink jet ink composition has improved storage stability and enables suppression of an odor during heating, and in addition, has excellent ejection stability.

Note that the textile printing ink jet ink composition according to the embodiment may include one or more other disperse dyes in addition to the thioindigo-skeleton-containing disperse dye described above.

Specific examples of the one or more other disperse dyes include, but are not limited to, the disperse dyes mentioned below. Note that some of the examples mentioned below are dyes generally classified as oil-soluble dyes, but, in this specification, oil-soluble dyes that have little or no water solubility and are in the form of dispersed particles when present in water are regarded as disperse dyes.

An example of a yellow disperse dye is C.I. Disperse Yellow 82. Other examples include C.I. Disperse Yellows 1, 3, 4, 5, 7, 8, 9, 13, 16, 23, 24, 30, 31, 33, 34, 39, 41, 42, 44, 49, 50, 51, 54, 56, 58, 60, 61, 63, 64, 66, 68, 71, 74, 76, 77, 78, 79, 83, 85, 86, 88, 90, 91, 93, 98, 99, 100, 104, 108, 114, 116, 118, 119, 122, 124, 126, 135, 140, 141, 149, 153, 160, 162, 163, 164, 165, 179, 180, 182, 183, 184, 186, 192, 198, 199, 201, 202, 204, 210, 211, 215, 216, 218, 224, 227, 231, 232, 233, and 245; and C.I. Solvent Yellows 2, 6, 14, 16, 21, 25, 29, 30, 33, 51, 56, 77, 80, 82, 88, 89, 93, 116, 150, 163, and 179.

Examples of an orange disperse dye include C.I. Disperse Oranges 1, 1:1, 3, 7, 11, 13, 17, 20, 21, 25, 25:1, 29, 30, 31, 32, 33, 37, 38, 41, 42, 43, 44, 45, 46, 47, 48, 49, 50, 51, 53, 54, 55, 56, 57, 58, 59, 61, 66, 71, 73, 76, 78, 80, 89, 90, 91, 93, 96, 97, 119, 127, 130, 139 and 142; and C.I. Solvent Oranges 1, 2, 14, 45, and 60.

Examples of a red disperse dye include C.I. Disperse Reds 1, 4, 5, 6, 7, 11, 12, 13, 15, 17, 27, 43, 44, 50, 52, 53, 54, 55, 55:1, 56, 58, 59, 60, 65, 70, 72, 73, 74, 75, 76, 78, 81, 82, 83, 84, 86, 86:1, 88, 90, 91, 92, 93, 96, 97, 99, 100, 101, 103, 104, 105, 106, 107, 108, 110, 111, 113, 116, 117, 118, 121, 122, 125, 126, 127, 128, 129, 131, 132, 134, 135, 137, 143, 145, 146, 151, 152, 153, 154, 157, 158, 159, 164, 167, 167:1, 169, 177, 179, 181, 183, 184, 185, 188, 189, 190, 190:1, 191, 192, 200, 201, 202, 203, 205, 206, 207, 210, 221, 224, 225, 227, 229, 239, 240, 257, 258, 277, 278, 279, 281, 288, 298, 302, 303, 310, 311, 312, 320, 324, and 328; and C.I. Solvent Reds 1, 3, 7, 8, 9, 18, 19, 23, 24, 25, 27, 49, 100, 109, 121, 122, 125, 127, 130, 132, 135, 218, 225, and 230.

Examples of a violet disperse dye include C.I. Disperse Violets 1, 4, 8, 10, 17, 18, 23, 24, 26, 27, 28, 29, 30, 31, 33, 35, 36, 37, 38, 40, 43, 46, 48, 50, 51, 52, 56, 57, 59, 61, 63, 69, and 77; and C.I. Solvent Violet 13.

Examples of a green disperse dye include C.I. Disperse Green 9 and C.I. Solvent Green 3.

Examples of a brown disperse dye include C.I. Disperse Browns 1, 2, 4, 9, 13, and 19; and C.I. Solvent Browns 3, and 5.

Examples of a blue disperse dye include C.I. Disperse Blues 3, 5, 6, 7, 9, 14, 16, 19, 20, 24, 26, 26:1, 27, 35, 43, 44, 52, 54, 55, 56, 58, 60, 61, 62, 64, 64:1, 71, 72, 72:1, 73, 75, 77, 77:1, 79, 81, 81:1, 82, 83, 85, 87, 88, 90, 91, 93, 94, 95, 96, 99, 102, 106, 108, 112, 113, 115, 118, 120, 122, 125, 128, 130, 131, 139, 141, 142, 143, 145, 146, 148, 149, 153, 154, 158, 165, 167, 171, 173, 174, 176, 181, 183, 185, 186, 187, 189, 197, 198, 200, 201, 205, 207, 211, 214, 224, 225, 241, 257, 259, 267, 268, 270, 284, 285, 287, 288, 291, 293, 295, 297, 301, 315, 330, 333, 354, 359, 360, and 367; and C.I. Solvent Blue 2, 11, 14, 24, 25, 35, 36, 38, 48, 55, 59, 63, 67, 68, 70, 73, 83, 105, 111, and 132.

Examples of a black disperse dye include C.I. Disperse Blacks 1, 2, 3, 10, 24, 26, 27, 28, 30, and 31; and C.I. Solvent Blacks 3, 5, 7, 23, 27, 28, 29, and 34.

The disperse dyes mentioned above may be used alone or in a combination of two or more.

The disperse dyes mentioned above are compounds that are water insoluble or have a low water solubility. However, all of the disperse dyes can be favorably dispersed in water by, for example, using a dispersing resin, provided that the concentration of the disperse dye is within a specific range. The dispersing resin will be described later. Note that the term “emulsification” may also be used in cases in which the disperse dye is an oil-soluble dye. Furthermore, the above-mentioned disperse dyes are slightly different from one another in dispersibility. That is, the suitable range for the concentration of the dispersing resin varies depending on the type of disperse dye, and dispersibility may vary depending on the type of dispersing resin.

A total content of the one or more disperse dyes in the textile printing ink jet ink composition is preferably 0.1 mass % or greater and 10.0 mass % or less, more preferably 0.2 mass % or greater and 9.0 mass % or less, and even more preferably 0.3 mass % or greater and 7.0 mass % or less, relative to the total mass of the ink composition taken as 100.0 mass %. When the content of the one or more disperse dyes in the ink composition is within any of the above-mentioned ranges, the resultant transfer product exhibits sufficient color development.

### 1.2. Elemental Sulfur

As described above, the textile printing ink jet ink composition according to the embodiment includes, as a dye, a thioindigo-skeleton-containing dye. Since a thioindigo-skeleton-containing dye is an organosulfur compound containing sulfur in the skeleton, the dye includes elemental sulfur derived from the raw material used for the synthesis remaining therein.

In cases in which an ink that contains a thioindigo-skeleton-containing dye is used for textile printing, an odor derived from the elemental sulfur may be produced during the heating of a fabric or an intermediate transfer medium that includes the applied ink. Furthermore, if the amount of elemental sulfur present in the ink is high, clogging may occur in the recording head and in a filter disposed in the ink flow path.

On the other hand, when sulfur derivatives such as free sulfur or sulfate ions are present in the ink, a dispersion stability of the ink can be achieved. This is because the sulfur derivatives bind to cations that reduce ink component dispersion stability, such as Na ions, K ions, and Ca ions. Accordingly, if the ink is made to be free of elemental sulfur by purification, the dispersion stability of the ink decreases, and, therefore, the storage stability of the ink decreases.

Accordingly, in the embodiment, the content of elemental sulfur is 0.01 ppm or greater and 500 ppm or less relative to the total mass of the ink composition. The content is preferably 0.1 ppm or greater and 300 ppm or less, more preferably 1 ppm or greater and 150 ppm or less, and even more preferably 20 ppm or greater and 100 ppm or less. When the content of elemental sulfur is within any of the above-mentioned ranges, the textile printing ink jet ink composition has excellent storage stability and enables suppression of an odor during heating. In addition, clogging of the recording head and the like during textile printing is suppressed from occurring, and, therefore, ejection stability is improved.

For the textile printing ink jet ink composition according to the embodiment, the content of elemental sulfur is adjusted by cleaning the dye or adding elemental sulfur to the ink. The cleaning of the dye may be carried out by, for example, repeating a process, such as washing with water, ultrafiltration, reverse osmosis, centrifugation, or filtration, thereby partially removing elemental sulfur.

Furthermore, the content of elemental sulfur in the ink composition can be determined by, for example, performing gas chromatography mass spectrometry (GC/MS) on the ink and calculating the area of the obtained peak corresponding to the S₈ sulfur component.

### 1.3. Dispersing Resin

It is preferable that the textile printing ink jet ink composition of the embodiment include a dispersing resin for dispersing the disperse dye. The disperse dye is dispersed with a dispersing resin. The dispersing resin has a function of dispersing or emulsifying the above-described disperse dye in the textile printing ink jet ink composition. Examples of the dispersing resin include, but are not limited to, the following resins.

Examples of the dispersing resin include acrylic-based resins, such as polyacrylic acids, acrylic acid-acrylonitrile copolymers, acrylic acid-acrylic acid ester copolymers, vinyl acetate-acrylic acid ester copolymers, vinyl acetate-acrylic acid copolymers, styrene-acrylic acid copolymers, styrene-methacrylic acid copolymers, styrene-methacrylic acid-acrylic acid ester copolymers, styrene-α-methylstyrene-acrylic acid copolymers, styrene-α-methylstyrene-acrylic acid-acrylic acid ester copolymers, and vinyl naphthalene-acrylic acid copolymers, and salts of the foregoing compounds; styrene-based resins, such as styrene-acrylic acid copolymers, styrene-methacrylic acid copolymers, styrene-methacrylic acid-acrylic acid ester copolymers, styrene-α-methylstyrene-acrylic acid copolymers, styrene-α-methylstyrene-acrylic acid-acrylic acid ester copolymers, styrene-maleic acid copolymers, and styrene-maleic anhydride copolymers, and salts of the foregoing compounds; urethane-based resins and salts thereof, the urethane-based resins being polymeric compounds containing urethane linkages formed by a reaction between isocyanate groups and hydroxyl groups, the polymeric compounds being linear and/or branched and having a crosslinked structure or no crosslinked structure; polyvinyl alcohols; polyvinylpyrrolidones; vinyl naphthalene-maleic acid copolymers and salts thereof; vinyl acetate-maleic acid ester copolymers and salts thereof; and vinyl acetate-crotonic acid copolymers and salts thereof.

Examples of commercially available products of styrene-based dispersing resins include X-200, X-1, X-205, and X-220, manufactured by Seiko PMC Corporation, and Nopco Sperse 6100, manufactured by San Nopco Limited. Examples of commercially available products of acrylic-based dispersing resins include BYK-190, BYK-187, BYK-191, BYK-194N, and BYK-199, manufactured by BYK Japan KK, and Aron A-6114, manufactured by Toagosei Co., Ltd. Examples of commercially available products of urethane-based dispersing resins include BYK-184, BYK-182, BYK-183, and BYK-185, manufactured by BYK Japan KK, and TEGO (registered trademark) Dispers 710, manufactured by Evonik Degussa.

The dispersing resins may be used alone or in a combination of two or more. In the textile printing ink jet ink composition, a total content of the one or more dispersing resins is preferably 0.1 mass % or greater and 20.0 mass % or less, more preferably 1.0 mass % or greater and 15.0 mass % or less, and even more preferably 2.0 mass % or greater and 10.0 mass % or less, relative to the total mass of the ink composition. When the content of the one or more dispersing resins is within any of the above-mentioned ranges, a dispersion stability of the dye is ensured, and in addition, the storage stability of the ink is improved. Furthermore, a viscosity of the ink can be in a suitable range.

Furthermore, it is more preferable that the dispersing resin be at least one selected from acrylic-based resins, styrene-based resins, and urethane-based resins, among the resins mentioned above. By using such a resin as the dispersing resin, the dispersion stability of the disperse dye can be enhanced.

### 1.4. Water-Soluble Organic Solvent

In the embodiment, it is preferable that the textile printing ink jet ink composition include a water-soluble organic solvent. When the ink composition includes a water-soluble organic solvent, an excellent ejection stability of the ink composition in an ink jet method is achieved, and also, it is possible to effectively suppress the evaporation of liquid from a recording head, which may occur when recording is not performed for a long period.

Examples of the water-soluble organic solvent include polyol compounds and glycol ethers.

Examples of the polyol compounds include polyol compounds having 2 to 6 carbon atoms in the molecule and optionally having an ether linkage in the molecule. Preferably, the polyol compounds include diol compounds, for example. Specific examples include glycols such as 1,2-pentanediol, glycerol, ethylene glycol, diethylene glycol, triethylene glycol, polyethylene glycol, propylene glycol, dipropylene glycol, tripropylene glycol, polypropylene glycol, polyoxyethylene polyoxypropylene glycol, 1,2-hexanediol, 1,2-heptanediol, 1,3-propanediol, 1,2-butanediol, 1,3-butanediol, 1,4-butanediol, 2,3-butanediol, 2-methyl-3-phenoxy-1,2-propanediol, 3-(3-methylphenoxy)-1,2-propanediol, 3-hexyloxy-1,2-propanediol, 2-hydroxymethyl-2-phenoxymethyl-1,3-propanediol, 3-methyl-1,3-butanediol, 1,3-propanediol, 1,2-butanediol, 1,2-pentanediol, 1,4-butanediol, 1,5-pentanediol, 1,6-hexanediol, 2-methyl-2,4-pentanediol, and 3-methyl-1,5-pentanediol.

Examples of the glycol ethers include monoalkyl ethers of glycol, and the glycol may be selected from, for example, ethylene glycol, diethylene glycol, triethylene glycol, polyethylene glycol, propylene glycol, dipropylene glycol, tripropylene glycol, polypropylene glycol, and polyoxyethylene polyoxypropylene glycol. Examples of the monoalkyl ethers include triethylene glycol monomethyl ether, triethylene glycol monobutyl ether, and dipropylene glycol monopropyl ether.

The water-soluble organic solvent may be a plurality of water-soluble organic solvents, which may be mixed together and used. Furthermore, in terms of adjusting the viscosity of the ink composition and preventing clogging by ensuring moisture retention, it is preferable that a content of the water-soluble organic solvent in the ink composition be 0.2 mass % or greater and 30.0 mass % or less relative to the total mass of the ink composition, and it is more preferable that the content be 1.0 mass % or greater and 25.0 mass % or less.

### 1.5. Water

In the embodiment, it is preferable that the textile printing ink jet ink composition include water. Examples of the water include pure water, such as ion exchanged water, ultrafiltrated water, reverse osmosis water, and distilled water, and water in which ionic impurities are minimized, such as ultrapure water. Furthermore, using sterilized water, which may be obtained by, for example, UV irradiation or addition of hydrogen peroxide, prevents the growth of bacteria or fungus when the ink composition is stored for a long period.

In the textile printing ink jet ink composition, a content of water is preferably 40.0 mass % or greater and 90.0 mass % or less and more preferably 50.0 mass % or greater and 85.0 mass % or less, relative to the total mass of the ink composition.

### 1.6. Other Components

### 1.6.1. Surface Tension Modifier

In the embodiment, the textile printing ink jet ink composition may include a surface tension modifier. The surface tension modifier reduces the surface tension of the ink when the surface tension modifier is dissolved in water. Accordingly, the surface tension modifier is used to adjust the wetting properties of the ink with respect to a printing substrate and an ejection path. Examples of the surface tension modifier include low-surface-tension water-soluble solvent-based surface tension modifiers and surfactant-based surface tension modifiers.

Examples of the water-soluble solvent-based surface tension modifiers include lower alcohols, such as ethanol, propanol, and butanol; diols, such as butylene glycol, 1,3-pentanediol, 2-ethyl-1,3-propanediol, and 1,6-hexanediol; and glycol monoethers, such as ethylene glycol monomethyl ether, ethylene glycol monoethyl ether, diethylene glycol monomethyl ether, diethylene glycol monoethyl ether, and propylene glycol monomethyl ether.

As the surfactant-based surface tension modifier, one or more may be appropriately selected from, for example, nonionic surfactants, anionic surfactants, cationic surfactants, and amphoteric surfactants. In particular, an acetylene glycol-based surfactant or a silicone-based surfactant, which has a high surface activity and a low foaming tendency, is preferable.

Examples of commercially available products of the acetylene glycol-based surfactant include, but are not limited to Olfine series E1004, E1010, E1020, PD-001, PD-002W, PD-004, PD-005, EXP. 4200, EXP. 4123, and EXP. 4300, and Surfynol series 440, 465, 485, CT111, CT121, TG, and GA, and Dynol series 604 and 607, manufactured by Nissin Chemical Industry Co., Ltd., and Acetylenol series E40, E60, and E100, manufactured by Kawaken Fine Chemicals Co., Ltd.

Examples of the silicone-based surfactant include polysiloxane-based compounds and polyether-modified organosiloxane. Examples of commercially available products of the silicone-based surfactant include, but are not limited to, BYK-306, BYK-307, BYK-333, BYK-341, BYK-345, BYK-346, BYK-347, BYK-348, and BYK-349, manufactured by BYK Japan KK, KF-351A, KF-352A, KF-353, KF-354L, KF-355A, KF-615A, KF-945, KF-640, KF-642, KF-643, KF-6020, X-22-4515, KF-6011, and KF-6012, manufactured by Shin-Etsu Chemical Co., Ltd., and Silface series SAG002, 005, 503A, and 008, manufactured by Nissin Chemical Industry Co., Ltd.

In the textile printing ink jet ink composition, a content of the surface tension modifier is preferably 0.01 mass % or greater and 2 mass % or less and more preferably 0.1 mass % or greater and 2.5 mass % or less, relative to the total mass of the ink composition.

### 1.6.2. pH Adjusting Agent

In the embodiment, it is preferable that the textile printing ink jet ink composition include a pH adjusting agent as necessary. The pH adjusting agent is not particularly limited and may be an appropriate combination of two or more selected from an acid, a base, a weak acid, and a weak base. Examples of acids and bases that may be used in such a combination include inorganic acids, inorganic bases, organic bases, and organic acids. Examples of the inorganic acids include sulfuric acid, hydrochloric acid, and nitric acid. Examples of the inorganic bases include lithium hydroxide, sodium hydroxide, potassium hydroxide, potassium dihydrogen phosphate, disodium hydrogen phosphate, potassium carbonate, sodium carbonate, sodium hydrogen carbonate, and ammonia. Examples of the organic bases include triethanolamine, diethanolamine, monoethanolamine, tripropanolamine, triisopropanolamine, diisopropanolamine, and tris(hydroxymethyl)aminomethane (THAM). Examples of the organic acids include adipic acid, citric acid, succinic acid, lactic acid, Good buffers such as N,N-bis(2-hydroxyethyl)-2-aminoethanesulfonic acid (BES), 4-(2-hydroxyethyl)-1-piperazine ethanesulfonic acid (HEPES), morpholinoethanesulfonic acid (MES), carbamoylmethylimino bisacetic acid (ADA), piperazine-1,4-bis(2-ethanesulfonic acid) (PIPES), N-(2-acetamido)-2-aminoethanesulfonic acid (ACES), cholamine chloride, N-tris(hydroxymethyl)methyl-2-aminoethane sulfonic acid (TES), acetamidoglycine, tricine, glycinamide, and bicine, phosphate buffers, citrate buffers, and Tris buffers. Among the above-mentioned compounds, a tertiary amine, such as triethanolamine or triisopropanolamine, and a carboxyl-group-containing organic acid, such as adipic acid, citric acid, succinic acid, or lactic acid, may be included as a portion or the whole of the pH adjusting agent. Inclusion of such materials is preferable because a pH buffering effect can be produced consistently.

### 1.6.3. Humectant

In the embodiment, the textile printing ink jet ink composition may include a humectant. The humectant is not particularly limited, and any humectant that is generally used in ink jet ink compositions may be used. The humectant preferably has a boiling point higher than or equal to 180° C. and more preferably higher than or equal to 200° C. When the humectant has a boiling point within any of the above-mentioned ranges, the humectant can impart a good liquid retention characteristic and wetting characteristic to the ink composition.

Specific examples of the humectant include polyols, such as diethylene glycol, triethylene glycol, tetraethylene glycol, pentamethylene glycol, trimethylene glycol, 2-butene-1,4-diol, 2-ethyl-1,3-hexanediol, 2-methyl-2,4-pentanediol, tripropylene glycol, isobutylene glycol, glycerol, diglycerol, mesoerythritol, trimethylolpropane, pentaerythritol, and dipentaerythritol; lactams, such as 2-pyrrolidone, N-methyl-2-pyrrolidone, ε-caprolactam, and hydroxyethyl pyrrolidone; urea and urea derivatives, such as thiourea, ethylene urea, and 1,3-dimethyl-imidazolidinones; monosaccharides, disaccharides, oligosaccharides, polysaccharides, and derivatives of the foregoing saccharides, such as, glucose, mannose, fructose, ribose, xylose, arabinose, galactose, aldonic acid, glucitol (sorbitol), maltose, cellobiose, lactose, sucrose, trehalose, and maltotriose; and glycine and trimethylglycine (betaine).

As used herein, the term “saccharides” refers to monosaccharides, disaccharides, oligosaccharides including trisaccharides and tetrasaccharides, and polysaccharides. Examples of the saccharides include threose, erythrulose, erythrose, arabinose, ribulose, ribose, xylose, xylulose, lyxose, glucose, fructose, mannose, idose, sorbose, gulose, talose, tagatose, galactose, allose, psicose, altrose, maltose, isomaltose, cellobiose, lactose, sucrose, trehalose, isotrehalose, gentiobiose, melibiose, turanose, sophorose, isosaccharose, homoglycans such as glucan, fructan, mannan, xylan, galacturonan, mannuronan, and an N-acetyl glucosamine polymer, heteroglycans such as diheteroglycans and triheteroglycans, maltotriose, isomaltotriose, panose, maltotetraose, and maltopentaose.

In the embodiment, when the textile printing ink jet ink composition includes a humectant, a content of the humectant in the ink composition is preferably 0.2 mass % or greater and 30.0 mass % or less and more preferably 0.5 mass % or greater and 25.0 mass % or less, relative to the total mass of the ink composition.

### 1.6.4. Chelating Agent

In the embodiment, the textile printing ink jet ink composition may include a chelating agent as necessary. Examples of the chelating agent include ethylenediamine tetraacetic acid and salts thereof. Examples of the salts include disodium dihydrogen ethylenediaminetetraacetate and also include nitrilotriacetate salts, hexametaphosphate salts, pyrophosphate salts, and metaphosphate salts of ethylenediamine.

### 1.6.5. Preservative and Fungicide

In the embodiment, a preservative and a fungicide may be used as necessary in the textile printing ink jet ink composition. Examples of the preservative and the fungicide include sodium benzoate, sodium pentachlorophenol, 2-pyridinethiol-1-oxide sodium, sodium sorbate, sodium dehydroacetate, 1,2-benzisothiazoline-3-one, and 4-chloro-3-methylphenol.

### 1.6.6. Others

Further, one or more additives that may be typically used in ink jet-use ink compositions may be included as necessary in addition to the components described above. Examples of the additives include corrosion inhibitors, antioxidants, UV absorbers, oxygen absorbers, and dissolution aids.

### 1.7. Physical Properties of Textile Printing Ink Jet Ink Composition and Production Thereof

In the embodiment, the textile printing ink jet ink composition preferably has a surface tension at 25° C. of 10 mN/m or greater and 40 mN/m or less and more preferably of 25 mN/m or greater and 40 mN/m or less. The surface tension can be measured in the following manner by using an automatic surface tensionmeter CBVP-Z, manufactured by Kyowa Interface Science Co. Ltd.; a platinum plate is wetted with the composition in an environment at 25° C., and the surface tension exhibited is determined.

In the embodiment, the textile printing ink jet ink composition preferably has a viscosity at 20° C. of 1.5 mPa·s or greater and 10 mPa·s or less and more preferably of 2 mPa·s or greater and 8 mPa·s or less. The surface tension and the viscosity can be controlled to be within the ranges mentioned above by appropriately selecting types of water-soluble organic solvent and surface tension modifier, described above, and appropriately adjusting, for example, the amounts of the water-soluble organic solvent, the surface tension modifier, and water. Note that the viscosity can be measured in the following manner by using a rheometer MCR-300, manufactured by Anton Paar Japan K.K.; the shear rate is increased from 10 to 1000 in an environment at 20° C., and the viscosity at the shear rate of 200 is read.

In the embodiment, the textile printing ink jet ink composition preferably has a pH of 5.8 or greater and 10.5 or less and more preferably of 6.0 or greater and 10.0 or less. When the ink composition has a pH within any of the above-mentioned ranges, corrosion of the recording head and the components of the ink jet recording apparatus, for example, can be suppressed.

In the embodiment, the textile printing ink jet ink composition can be obtained by mixing together the above-described components in any order and, as necessary, performing filtration or the like to remove impurities. A suitable method for mixing together the components is a method in which the materials are successively added to a vessel equipped with a stirring device, such as a mechanical stirrer or a magnetic stirrer, and are then mixed together with stirring. Furthermore, the disperse dye may be added in the form of a dispersion in which the disperse dye is already dispersed with a dispersing resin.

### 1.8. Advantageous Effect

The textile printing ink jet ink composition according to the embodiment is suitable for use in a textile printing method, which is a dyeing method that utilizes sublimation transfer and is performed on a fabric or the like. Specifically, the textile printing ink jet ink composition according to the embodiment is used in a textile printing method, which is described below. In the method, the dye is deposited onto a transfer sheet by using an ink jet method to form a transfer image, and the transfer image is transferred to a fabric. In this manner, a transfer product can be obtained. In the textile printing ink jet ink composition according to the embodiment, the content of elemental sulfur is 0.01 ppm or greater and 500 ppm or less relative to the total mass of the ink composition. As a result, an odor during the heating of a fabric or an intermediate transfer medium is suppressed. Furthermore, the textile printing ink jet ink composition has excellent storage stability.

### 2. TEXTILE PRINTING METHOD

The textile printing method according to an embodiment includes a deposition step and a transfer step. In the deposition step, a textile printing ink jet ink composition is deposited onto a transfer sheet by using an ink jet method. In the transfer step, which is performed after the deposition step, the transfer sheet and a recording medium are positioned to face each other and heated. The textile printing ink jet ink composition includes a thioindigo-skeleton-containing dye and elemental sulfur. A content of the elemental sulfur in the textile printing ink jet ink composition is 0.01 ppm or greater and 500 ppm or less relative to the total mass of the ink composition.

An example of a textile printing method utilizing sublimation transfer is as follows. With an ink jet method, printing is performed on a sheet-shaped intermediate transfer medium, such as a transfer sheet, by using an ink composition containing a disperse dye that is a sublimation dye, thereby forming a transfer image. Thereafter, the intermediate transfer medium is laid over a transfer target medium, such as a fabric, and then heating is performed to transfer the obtained transfer image by sublimation.

That is, the textile printing method according to the embodiment includes at least a deposition step and a transfer step. In the deposition step, the textile printing ink jet ink composition described above is deposited onto a transfer sheet by using an ink jet method. In the transfer step, which is performed after the deposition step, the transfer sheet and a recording medium, such as a fabric, are positioned to face each other and heated, thereby causing the disperse dye included in the textile printing ink jet ink composition to be transferred from the transfer sheet by sublimation to the recording medium.

### 2.1. Deposition Step

In this step, the textile printing ink jet ink composition described above is ejected from a recording head by using an ink jet method, thereby depositing the ink composition on the recording surface of a transfer sheet, which is an intermediate transfer medium, to form a transfer image. The ejection of the composition with an ink jet method can be carried out by using a droplet ejection apparatus, such as an ink jet recording apparatus.

The ink jet recording apparatus that can be used in the embodiment is not particularly limited provided that the apparatus includes at least an ink reservoir, such as a cartridge or a tank, for storing the textile printing ink jet ink composition described above and a recording head coupled to the ink reservoir, and that the ink can be ejected from the recording head to form an image on a transfer sheet, which is an intermediate transfer medium. Furthermore, the ink jet recording apparatus may be a serial-type apparatus or a line-type apparatus. The ink jet recording apparatuses of these types are equipped with a recording head. From the nozzle holes of the recording head, droplets of the ink composition are ejected intermittently at predetermined timings and in a predetermined volume while varying the relative positional relationship between the transfer sheet and the recording head. In this manner, the ink composition can be deposited on the transfer sheet to form a predetermined transfer image.

In general, in ink jet recording apparatuses of the serial type, the recording medium travel direction and the recording head reciprocating motion direction cross each other, and accordingly, the relative positional relationship between the recording medium and the recording head is varied with various combinations of the reciprocating motion of the recording head and the travel motion of the recording medium. Furthermore, in this case, the recording head typically includes a plurality of nozzle holes, which constitute a nozzle hole array, that is, a nozzle array, formed along the recording medium travel direction. Furthermore, in the recording head, a plurality of nozzle arrays may be formed corresponding to types of ink compositions and/or the number of ink compositions.

Furthermore, in general, in ink jet recording apparatuses of the line type, there is no reciprocating motion of the recording head; the relative positional relationship between the recording medium and the recording head is varied by utilizing the traveling of the recording medium to vary the relative positional relationship between the recording medium and the recording head. In this case, too, the recording head typically includes a plurality of nozzle holes, which constitute a nozzle array formed along a direction crossing the recording medium travel direction.

The ink jet recording process is not particularly limited provided that the ink composition can be ejected as droplets from the fine nozzle holes to deposit the droplets on a recording medium. For example, the ink jet recording process may be a piezoelectric process, a process in which ink is heated to form bubbles, which are utilized to eject the ink, or a different process. In the embodiment, it is preferable to use a piezoelectric process because, for example, with a piezoelectric process, the ink composition is less likely to deteriorate.

In the ink jet recording apparatus used in the embodiment, one or more elements known in the art may be employed without limitations. Examples of such elements include a heating unit, a drying unit, a roll unit, and a take-up device.

In the embodiment, the transfer sheet, which is an intermediate transfer medium, may be, for example, paper such as plain paper, paper exclusively for ink jet use, or a recording medium including an ink-receiving layer, such as coated paper. Particularly, paper including an ink-receiving layer formed of inorganic microparticles, such as silica microparticles, is preferable. With such paper, it is possible to obtain an intermediate recorded product in which smearing on the recording surface and the like are suppressed, which may occur in the process in which the ink composition provided on the intermediate transfer medium dries. Furthermore, with such a medium, the sublimation dye can be easily retained on the surface of the recording surface, and, therefore, the sublimation of the disperse dye can be efficiently carried out in the subsequent transfer step.

### 2.2. Transfer Step

The textile printing method according to the embodiment includes the transfer step, which is carried out in the following manner. Heating is performed in a state in which the recording surface of a transfer sheet, which includes the textile printing ink jet ink composition provided thereon, faces a recording medium that is a textile printing target, such as a polyester fabric, in other words, in a state in which a recording medium such as a fabric is disposed on the recording surface of a transfer sheet. Accordingly, the disperse dye included in the ink composition is sublimated to the textile printing target, thereby accomplishing the transfer onto the recording medium. In this manner, a printed textile product, that is, a transfer product, formed by using a recording medium such as a fabric as a textile printing target can be obtained.

The heating temperature in the transfer step is not particularly limited but is preferably 160° C. or higher and 240° C. or lower, more preferably 180° C. or higher and 220° C. or lower, and even more preferably 170° C. or higher and 210° C. or lower. With such a heating temperature, sufficient energy can be produced for transferring the thioindigo-skeleton-containing dye to a textile printing target. As a result, a high productivity for producing printed textile products is achieved. In addition, an odor during the heating of a fabric or an intermediate transfer medium can be suppressed.

The transfer time in the transfer step may depend on the heating temperature but is preferably 20 seconds or more and 100 seconds or less, more preferably 40 seconds or more and 80 seconds or less, and even more preferably 50 seconds or more and 70 seconds or less. With such a transfer time, sufficient energy can be produced for transferring the thioindigo-skeleton-containing dye to a textile printing target. As a result, a particularly high productivity for producing printed textile products is achieved. In addition, an odor during the heating of a fabric or an intermediate transfer medium can be suppressed.

Furthermore, it is sufficient that the transfer step be carried out by heating the transfer sheet including the ink composition provided thereon, in a state in which the transfer sheet faces the textile printing target; however, it is preferable that the heating be performed in a state in which the transfer sheet is in close contact with the textile printing target. Accordingly, for example, a transfer product in which a clearer image is recorded on a fabric or the like can be obtained.

An example of the textile printing target is a polyester fabric, which is a hydrophobic fiber fabric. Other examples that may be used include sheet-shaped objects, such as resin films, and objects having a three-dimensional shape, instead of a sheet shape, such as objects having a spherical shape, objects having a parallelepiped shape, and objects having a curved surface.

### 2.3. Other Steps

The textile printing method according to the embodiment may include a step of heating the transfer sheet that is performed after the deposition step. This step is a step of performing heating after the textile printing ink jet ink composition is ejected and deposited onto the transfer sheet. Performing this step facilitates the drying of the textile printing ink jet ink composition deposited in the deposition step, and as a result, smearing of the image is suppressed, and offset may also be suppressed. Note that the term “offset” refers to a phenomenon in which, when, for example, portions of the transfer sheet overlap each other, such as when the transfer sheet is taken up on a roll, a component of the ink composition is transferred to a back surface that is in contact with a recording surface. In the textile printing method according to the embodiment, the textile printing ink jet ink composition described above is used, and, therefore, an odor during the heating of the intermediate transfer medium can be suppressed.

A maximum temperature of the transfer sheet in this step is preferably higher than or equal to 60° C. and more preferably 70° C. or higher and 120° C. or lower. When the maximum temperature is within such a range, the disperse dye tends not to sublimate, and a favorable drying rate can be achieved. Furthermore, the use of the textile printing ink jet ink composition described above suppresses an odor.

In addition, the textile printing method of the embodiment may include a step of heating at least one of the recording head and the transfer sheet in the deposition step. In addition, the textile printing method of the embodiment may include a step of disposing a fabric on the recording surface of the transfer sheet and a step of heating the transfer sheet and the fabric.

The textile printing method according to the embodiment uses the textile printing ink jet ink composition, in which the content of elemental sulfur is 0.01 ppm or greater and 500 ppm or less relative to the total mass of the ink composition. Consequently, an odor during the heating of the fabric or the intermediate transfer medium is suppressed. Furthermore, the use of the ink, which has excellent storage stability, ensures excellent ejection stability in the method.

In addition, selection of an appropriate transfer temperature and transfer time enhances ejection stability and ensures suppression of an odor in the textile printing method. In addition, selection of an amount of the thioindigo-skeleton-containing dye in an appropriate range ensures excellent color development in the textile printing method.

### 3. EXAMPLES

The present disclosure will now be described in more detail with reference to examples and comparative examples. However, the present disclosure is not limited to the examples. In the examples and comparative examples, “parts” means “parts by mass”, and “%” means “mass %” unless otherwise specified.

### 3.1. Preparation of Ink Composition

The ingredients were placed in a vessel such that each of the compositions shown in Tables 1 and 2 was achieved, and then the ingredients were mixed together and stirred for 2 hours with a magnetic stirrer, and thereafter, the mixture was subjected to a dispersion process in a bead mill loaded with zirconia beads having a diameter of 0.3 mm, to be thoroughly mixed. After being stirred for 1 hour, the mixture was filtered through a 5-μm PTFE membrane filter. In this manner, the ink compositions according to the examples and the comparative examples were obtained. The numerical values in Tables 1 and 2 are expressed on a mass % basis. The water used was ion-exchanged water, which was added such that the mass of each of the ink compositions was 100 mass %. Cleaning of the colorant or addition of elemental sulfur was performed such that the concentrations of elemental sulfur in the ink compositions shown in Tables 1 and 2 were achieved.

TABLE 1

| | | | | | | | Changing of sulfur |
|---|---|---|---|---|---|---|---|
| | | Changing of colorant | | | | | concentration |
| | | Example | Example | Example | Example | Example | Example |
| Object | | 1 | 2 | 3 | 4 | 5 | 6 |
| Colorant | Disperse Red 364 | 4.0 | | | | | 4.0 |
| (mass %) | Vat Orange 5 | | 4.0 | | | | |
| | Vat Violet 2 | | | 4.0 | | | |
| | Vat Red 5 | | | | 4.0 | | |
| | Vat Red 6 | | | | | 4.0 | |
| Composition | Glycerol | 20.0 | 20.0 | 20.0 | 20.0 | 20.0 | 20.0 |
| (mass %) | Propylene glycol | 5.0 | 5.0 | 5.0 | 5.0 | 5.0 | 5.0 |
| | Triethylene glycol | 3.0 | 3.0 | 3.0 | 3.0 | 3.0 | 3.0 |
| | monomethyl ether | | | | | | |
| | Silface SAG503A | 1.0 | 1.0 | 1.0 | 1.0 | 1.0 | 1.0 |
| | Latemul WX | 1.0 | 1.0 | 1.0 | 1.0 | 1.0 | 1.0 |
| | Triethanolamine | 1.0 | 1.0 | 1.0 | 1.0 | 1.0 | 1.0 |
| | Adipic acid | 1.0 | 1.0 | 1.0 | 1.0 | 1.0 | 1.0 |
| | Proxel XL-2 | 1.0 | 1.0 | 1.0 | 1.0 | 1.0 | 1.0 |
| | Sodium iminodisuccinate | 1.0 | 1.0 | 1.0 | 1.0 | 1.0 | 1.0 |
| | Benzotriazole | 1.0 | 1.0 | 1.0 | 1.0 | 1.0 | 1.0 |
| | Water | Balance | Balance | Balance | Balance | Balance | Balance |

| | | | | | | |
|---|---|---|---|---|---|---|
| Sulfur concentration (ppm) | 100 | 100 | 100 | 100 | 100 | 500 |
| Transfer temperature (° C.) | 200 | 200 | 200 | 200 | 200 | 200 |
| Transfer time (s) | 60 | 60 | 60 | 60 | 60 | 60 |
| Odor | 1 | 1 | 1 | 1 | 1 | 3 |
| Storage stability | 1 | 1 | 1 | 1 | 1 | 1 |
| Nozzle failure | 1 | 1 | 1 | 1 | 1 | 3 |
| Color saturation | 1 | 1 | 1 | 1 | 1 | 1 |

| | | Changing of sulfur concentration | | | | | |
|---|---|---|---|---|---|---|---|
| | | Example | Example | Example | Example | Comparative | Comparative |
| Object | | 7 | 8 | 9 | 10 | example 1 | example 2 |
| Colorant | Disperse Red 364 | 4.0 | 4.0 | 4.0 | 4.0 | 4.0 | 4.0 |
| (mass %) | Vat Orange 5 | | | | | | |
| | Vat Violet 2 | | | | | | |
| | Vat Red 5 | | | | | | |
| | Vat Red 6 | | | | | | |
| Composition | Glycerol | 20.0 | 20.0 | 20.0 | 20.0 | 20.0 | 20.0 |
| (mass %) | Propylene glycol | 5.0 | 5.0 | 5.0 | 5.0 | 5.0 | 5.0 |
| | Triethylene glycol | 3.0 | 3.0 | 3.0 | 3.0 | 3.0 | 3.0 |
| | monomethyl ether | | | | | | |
| | Silface SAG503A | 1.0 | 1.0 | 1.0 | 1.0 | 1.0 | 1.0 |
| | Latemul WX | 1.0 | 1.0 | 1.0 | 1.0 | 1.0 | 1.0 |
| | Triethanolamine | 1.0 | 1.0 | 1.0 | 1.0 | 1.0 | 1.0 |
| | Adipic acid | 1.0 | 1.0 | 1.0 | 1.0 | 1.0 | 1.0 |
| | Proxel XL-2 | 1.0 | 1.0 | 1.0 | 1.0 | 1.0 | 1.0 |
| | Sodium iminodisuccinate | 1.0 | 1.0 | 1.0 | 1.0 | 1.0 | 1.0 |
| | Benzotriazole | 1.0 | 1.0 | 1.0 | 1.0 | 1.0 | 1.0 |
| | Water | Balance | Balance | Balance | Balance | Balance | Balance |

| | | | | | | |
|---|---|---|---|---|---|---|
| Sulfur concentration (ppm) | 150 | 25 | 1 | 0.01 | 0.001 | 800 |
| Transfer temperature (° C.) | 200 | 200 | 200 | 200 | 200 | 200 |
| Transfer time (s) | 60 | 60 | 60 | 60 | 60 | 60 |
| Odor | 2 | 1 | 1 | 1 | 1 | 5 |
| Storage stability | 1 | 1 | 2 | 3 | 4 | 1 |
| Nozzle failure | 2 | 1 | 1 | 1 | 1 | 5 |
| Color saturation | 1 | 1 | 1 | 1 | 1 | 1 |

TABLE 2

| | | Changing of colorant concentration | | | | Changing of transfer temperature | | | |
|---|---|---|---|---|---|---|---|---|---|
| | | Example | Example | Example | Example | Example | Example | Example | Example |
| Object | | 11 | 12 | 13 | 14 | 15 | 16 | 17 | 18 |
| Colorant | Disperse Red 364 | 10.0 | 7.0 | 1.0 | 0.1 | 4.0 | 4.0 | 4.0 | 4.0 |
| (mass %) | Vat Orange 5 | | | | | | | | |
| | Vat Violet 2 | | | | | | | | |
| | Vat Red 5 | | | | | | | | |
| | Vat Red 6 | | | | | | | | |
| Composition | Glycerol | 20.0 | 20.0 | 20.0 | 20.0 | 20.0 | 20.0 | 20.0 | 20.0 |
| (mass %) | Propylene glycol | 5.0 | 5.0 | 5.0 | 5.0 | 5.0 | 5.0 | 5.0 | 5.0 |
| | Triethylene glycol | 3.0 | 3.0 | 3.0 | 3.0 | 3.0 | 3.0 | 3.0 | 3.0 |
| | monomethyl ether | | | | | | | | |
| | Silface SAG503A | 1.0 | 1.0 | 1.0 | 1.0 | 1.0 | 1.0 | 1.0 | 1.0 |
| | Latemul WX | 1.0 | 1.0 | 1.0 | 1.0 | 1.0 | 1.0 | 1.0 | 1.0 |
| | Triethanolamine | 1.0 | 1.0 | 1.0 | 1.0 | 1.0 | 1.0 | 1.0 | 1.0 |
| | Adipic acid | 1.0 | 1.0 | 1.0 | 1.0 | 1.0 | 1.0 | 1.0 | 1.0 |
| | Proxel XL-2 | 1.0 | 1.0 | 1.0 | 1.0 | 1.0 | 1.0 | 1.0 | 1.0 |
| | Sodium iminodisuccinate | 1.0 | 1.0 | 1.0 | 1.0 | 1.0 | 1.0 | 1.0 | 1.0 |
| | Benzotriazole | 1.0 | 1.0 | 1.0 | 1.0 | 1.0 | 1.0 | 1.0 | 1.0 |
| | Water | Balance | Balance | Balance | Balance | Balance | Balance | Balance | Balance |

| | | | | | | | | |
|---|---|---|---|---|---|---|---|---|
| Sulfur concentration (ppm) | 100 | 100 | 100 | 100 | 100 | 100 | 100 | 100 |
| Transfer temperature (° C.) | 200 | 200 | 200 | 200 | 160 | 180 | 220 | 240 |
| Transfer time (s) | 60 | 60 | 60 | 60 | 60 | 60 | 60 | 60 |
| Odor | 3 | 2 | 1 | 1 | 1 | 1 | 2 | 3 |
| Storage stability | 2 | 2 | 2 | 3 | 1 | 1 | 1 | 1 |
| Nozzle failure | 3 | 2 | 1 | 1 | 1 | 1 | 1 | 1 |
| Color saturation | 1 | 1 | 2 | 3 | 3 | 2 | 1 | 1 |

| | | Changing of transfer time | | | |
|---|---|---|---|---|---|
| | | Example | Example | Example | Example |
| Object | | 19 | 20 | 21 | 22 |
| Colorant | Disperse Red 364 | 4.0 | 4.0 | 4.0 | 4.0 |
| (mass %) | Vat Orange 5 | | | | |
| | Vat Violet 2 | | | | |
| | Vat Red 5 | | | | |
| | Vat Red 6 | | | | |
| Composition | Glycerol | 20.0 | 20.0 | 20.0 | 20.0 |
| (mass %) | Propylene glycol | 5.0 | 5.0 | 5.0 | 5.0 |
| | Triethylene glycol | 3.0 | 3.0 | 3.0 | 3.0 |
| | monomethyl ether | | | | |
| | Silface SAG503A | 1.0 | 1.0 | 1.0 | 1.0 |
| | Latemul WX | 1.0 | 1.0 | 1.0 | 1.0 |
| | Triethanolamine | 1.0 | 1.0 | 1.0 | 1.0 |
| | Adipic acid | 1.0 | 1.0 | 1.0 | 1.0 |
| | Proxel XL-2 | 1.0 | 1.0 | 1.0 | 1.0 |
| | Sodium iminodisuccinate | 1.0 | 1.0 | 1.0 | 1.0 |
| | Benzotriazole | 1.0 | 1.0 | 1.0 | 1.0 |
| | Water | Balance | Balance | Balance | Balance |

| | | | | |
|---|---|---|---|---|
| Sulfur concentration (ppm) | 100 | 100 | 100 | 100 |
| Transfer temperature (° C.) | 200 | 200 | 200 | 200 |
| Transfer time (s) | 20 | 40 | 80 | 100 |
| Odor | 1 | 1 | 2 | 3 |
| Storage stability | 1 | 1 | 1 | 1 |
| Nozzle failure | 1 | 1 | 1 | 1 |
| Color saturation | 3 | 2 | 1 | 1 |

Details of the ingredients shown in Tables 1 and 2, except for the colorants and the ingredients indicated by the compound names, are as follows.

Silface SAG503A (trade name): a silicone-based surfactant manufactured by Nissin Chemical Industry Co., Ltd.

Latemul WX (trade name): an emulsifier for emulsion polymerization, sodium polyoxyethylene alkyl ether sulfate, manufactured by Kao Corporation

Proxel XL-2 (trade name): a preservative, 1,2-benzisothiazoline-3-one, manufactured by Lonza Japan

The contents of elemental sulfur shown in Tables 1 and 2 are contents measured in the following manner by using a GC/MS instrument. First, the ink composition was heated to 300° C. in a pyrolyzer, and the volatile components in the ink composition were collected by using liquid nitrogen to obtain a sample for GC/MS. Next, the sample was analyzed by GC/MS, and the content of S₈ sulfur was determined by calculating the area of the peak corresponding to the S₈ sulfur component. The conditions for the GC/MS analysis were as follows.

Devices Used
Gas chromatograph: GC/MS 6890 series 6890 (trade name), manufactured by Agilent Technologies Inc.
Mass selective detector: Agilent 5975 (trade name), manufactured by Agilent Technologies Inc.
GC column: Ultra ALLOY (trade name), manufactured by Frontier Laboratories; length, 30 m; internal diameter, 0.25 mm; and film thickness, 0.25 μm

He flow rate: 1 mL/min

### 3.2. Preparation of Intermediate Transfer Product

Each of the ink compositions of the examples and the comparative examples was separately loaded into an ink jet printer PX-G930 (manufactured by Seiko Epson Corporation). Subsequently, the recording head of the printer was checked. It was found that there were no clogged nozzles, and thus normal recording could be performed. Next, with this ink jet printer, a pattern was printed on a transfer sheet, namely, a TRANSJET Classic (manufactured by Cham Paper Group). The amount of deposition of each of the ink compositions for forming the pattern was 70%. The recording resolution was 1440×720 dpi, and the printer was operated in a 25° C. environment. For each of the ink compositions, the pattern was printed on two sheets.

### 3.3. Transfer Step

The ink-deposited side of the intermediate transfer medium, on which the ink was deposited, was brought into close contact with 100% polyester taffeta (manufactured by Toray Industries, Inc.). In this state, heating was performed by using a heat press machine TP-608M (manufactured by Taiyoseiki Co., Ltd.) to carry out sublimation transfer. The conditions for the sublimation transfer included a transfer pressure of 1 N/cm², a transfer temperature of 180° C., and a transfer time of 60 seconds. Thus, transfer products were obtained.

### 3.4. Evaluation Tests

The following evaluation tests were conducted on the obtained transfer products.

### 3.4.1. Odor Evaluation

With reference to the odor evaluation of Material Analysis & Research Center, the air after the transfer was collected in a 3-L ink bag, and evaluations were made according to the following evaluation criteria.

Evaluation Criteria
1: No sulfur odor was sensed
2: A very slight sulfur odor was sensed
3: A slight sulfur odor was sensed
4: A sulfur odor was sensed
5: A strong sulfur odor was sensed

### 3.4.2. Storage Stability Evaluation

For each of the inks, the evaluation was made by examining a change in viscosity that occurred with time. Specifically, each of the inks was left to stand at 70° C. for one week. By using a measured initial viscosity of the ink and a viscosity of the ink measured after the ink was left to stand, evaluations were made according to the following evaluation criteria.

### Evaluation Criteria

1: The change in viscosity was not greater than ±3%
2: The change in viscosity was greater than ±3% and not greater than ±6%
3: The change in viscosity was greater than ±6% and not greater than ±9%
4: The change in viscosity was greater than ±9% and not greater than ±12%
5: The change in viscosity was greater than ±12%

### 3.4.3. Nozzle Failure Evaluation

Each of the obtained ink compositions was loaded into an ink reservoir, and the ink reservoir was attached to a printer PX-H6000 (trade name, manufactured by Seiko Epson Corporation). The printer was checked in advance and was found to be able to perform normal recording. Subsequently, each of the ink compositions was ejected from the printer by using a printer driver. The number of nozzles that caused a nozzle failure was measured, and evaluations were made according to the following evaluation criteria. As used herein, the term “nozzle failure” refers to missing dots caused by misfiring and displaced dots caused by erroneous firing.

Evaluation Criteria
1: The number of nozzle failures was 0
2: The number of nozzle failures was 1 to 5
3: The number of nozzle failures was 6 to 10
4: The number of nozzle failures was 11 to 20
5: The number of nozzle failures was 21 or more

### 3.4.4. Color Saturation Evaluation

Each of the obtained recorded products was evaluated for color development. Specifically, the OD (optical density) values of the obtained transfer products were measured using a densitometer Gretag Macbeth Spectrolino (trade name, manufactured by X-Rite Inc.). Based on the OD values, evaluations were made according to the following evaluation criteria.

Evaluation Criteria
1: The OD value of the recorded area was 0.95 or more
2: The OD value of the recorded area was 0.85 or more and less than 0.95
3: The OD value of the recorded area was 0.75 or more and less than 0.85

### 3.5. Evaluation Results

Examples in which a thioindigo-skeleton-containing dye was used and the content of elemental sulfur was 0.01 ppm or greater and 500 ppm or less had a rating of 3 or higher for all of the evaluations. A detailed description is provided below.

In Table 1, Examples 1 to 5 are examples that are different from one another in the type of colorant. In all of the cases in which different colorants were used, the same result was obtained.

In Table 1, Examples 6 to 10 and Comparative Examples 1 and 2 are examples that are different from one another in the sulfur concentration. The case in which the content of elemental sulfur was 25 ppm or greater and 100 ppm or less had a rating of 1 for all of the evaluations, as compared with Example 1. In the cases in which the content of elemental sulfur was greater than 100 ppm, the odor and nozzle failure ratings dropped. In the case in which the content of elemental sulfur was increased to as high as 800 ppm, a strong sulfur odor was sensed, and in addition, the number of nozzle failures increased. On the other hand, in the cases in which the content of elemental sulfur was less than 25 ppm, storage stability decreased as the content of elemental sulfur decreased. Note that color saturation was not affected by the changes in the sulfur concentration.

In Table 2, Examples 11 to 14 are examples that are different from one another in the colorant concentration. In Examples 13 and 14, in which the contents of the colorant were not greater than 1 mass %, storage stability and color saturation decreased, as compared with Example 1. On the other hand, in the cases in which the content of the colorant was high, storage stability also decreased, and in addition, the odor and nozzle failure ratings dropped.

In Table 2, Examples 15 to 18 are examples that are different from one another in the transfer temperature. In the cases in which the transfer temperature was low, color saturation decreased, and in the cases in which the transfer temperature was high, an odor was produced, as compared with Example 1.

In Table 2, Examples 19 to 22 are examples that are different from one another in the transfer time. In the cases in which the transfer times were short, color saturation decreased, and in the cases in which the transfer times were long, an odor was produced, as compared with Example 1.

The above results demonstrate the following. Since the content of elemental sulfur was 0.01 ppm or greater and 500 ppm or less in the textile printing ink jet ink compositions that included a thioindigo-skeleton-containing dye, the textile printing ink jet ink compositions had excellent storage stability and enabled suppression of an odor during heating. Furthermore, when the content of elemental sulfur, the content of a colorant, the transfer temperature, and the transfer time were in appropriate ranges, storage stability and odor ratings were improved, and in addition, nozzle failures during recording were suppressed, and color development was improved.

The present disclosure is not limited to the embodiments described above, and various other modifications may be made. For example, the present disclosure includes configurations substantially identical with the configurations described in the embodiments (e.g., configurations in which functions, methods, and results are identical or configurations in which objects and effects are identical). Furthermore, the present disclosure includes configurations in which one or more non-essential elements of the configurations described in the embodiments are replaced with different elements. Furthermore, the present disclosure includes configurations that produce an effect identical with that of the configurations described in the embodiments or configurations that make it possible to achieve an object identical with that of the configurations. Furthermore, the present disclosure includes configurations in which one or more elements of the known art are added to any of the configurations described in the embodiments.

What is claimed is:

1. A textile printing ink jet ink composition comprising:
a thioindigo-skeleton-containing dye; and
elemental sulfur, wherein
a content of the elemental sulfur is 0.01 ppm or greater and 500 ppm or less relative to a total mass of the textile printing ink jet ink composition.

2. The textile printing ink jet ink composition according to claim 1, wherein the content of the elemental sulfur is 20 ppm or greater and 100 ppm or less relative to the total mass of the textile printing ink jet ink composition.

3. The textile printing ink jet ink composition according to claim 1, wherein the thioindigo-skeleton-containing dye is at least one selected from the group consisting of C.I. Disperse Red 364, C.I. Vat Orange 5, C.I. Vat Red 1, C.I. Vat Red 5, C.I. Vat Red 6, C.I. Vat Violet 3, and C.I. Vat Violet 4.

4. The textile printing ink jet ink composition according to claim 1, wherein a content of the thioindigo-skeleton-containing dye is 0.1 mass % or greater and 10.0 mass % or less relative to the total mass of the textile printing ink jet ink composition.

5. A textile printing method comprising:
a deposition step of depositing a textile printing ink jet ink composition onto a transfer sheet by using an ink jet method; and
a transfer step of, after the deposition step, positioning the transfer sheet and a recording medium to face each other and heating the transfer sheet and the recording medium, wherein
the textile printing ink jet ink composition includes a thioindigo-skeleton-containing dye and elemental sulfur, and a content of the elemental sulfur in the textile printing ink jet ink composition is 0.01 ppm or greater and 500 ppm or less relative to a total mass of the textile printing ink jet ink composition.

6. The textile printing method according to claim 5, wherein a transfer temperature in the transfer step is 160° C. or higher and 240° C. or lower.

7. The textile printing method according to claim 5, wherein a transfer time in the transfer step is 20 seconds or more and 100 seconds or less.
